(19) United States
(12) Patent Application Publication
(10) Pub. No.: US 2018/0258916 A1
(43) Pub. Date: Sep. 13, 2018

(54) BLADE FOR WIND POWER GENERATION OR WIND POWER GENERATION DEVICE

(71) Applicant: Hitachi, Ltd., Tokyo (JP)

(72) Inventors: Takahiko SAWADA, Tokyo (JP); Mitsuru SAEKI, Tokyo (JP)

(21) Appl. No.: 15/913,101

(22) Filed: Mar. 6, 2018

(30) Foreign Application Priority Data
Mar. 7, 2017 (JP) 2017-042332

(51) Int. Cl. F03D 17/00; F03D 1/06

(52) U.S. Cl. CPC F03D 17/00; F03D 1/0675

(57) ABSTRACT

The present invention is intended to provide a blade for wind power generation or a wind power generation device that can measure the quantity of blade deformation with a simple structure while enhancing the reliability of structure. The blade includes a front tip part 10, a rear tip part 11, and a spar cap 17 configured to contain a fiber reinforcing layer, a shell core 18c arranged at least between the front tip part 10 and the spar caps 17 or between the rear tip part 11 and the spar caps 17, and a non-conductor sensor 12, wherein a concave is formed in a surface of the shell core 18c and the non-conductor sensor 12, and the non-conductor sensor 12 is arranged in the concave.

### TECHNICAL FIELD

The present invention relates to a blade for wind power generation or a wind power generation device.

### BACKGROUND ART

In recent years, from the viewpoint of addressing environmental problems including global warming, the demand for wind power generation facilities, which discharge no greenhouse effect gas at the time of power generation, has been growing. Wind power generation facilities are enabled to rotate by receiving winds and convert the rotational energy into electricity. In recent years, for the purpose of enhancing the efficiency of power generation, blades for wind power generation are made longer and larger. Blades for wind power generation are subjected to bending deformation and torsional deformation. For this reason, as blades increase in length and size, the quantities of bending deformation and torsional deformation increase.

Windmill blades, in spite of their greater frequency of being subjected to heavy loads than bridges and industrial plants, their maintenance intervals are longer than for aircraft and the like. Also, since windmill blades are required to be lighter in weight and greater in strength, laminated materials consisting of fiber-reinforced plastics (FRP) are often used. Such FRP laminated materials may suffer quick progress of damage starting from inter-layer peeling or resin cracking. A technique that allows constant monitoring of the structural soundness of blades is called for so that such damage may not arise.

Typical physical quantities for determining the soundness of structures include the quantity of deformation. In order to keep track of the quantity of deformation occurring in blades when windmills operate, incorporation of conductors into supporting structural bodies formed of glass fiber bundles or epoxy resin or in carriers removably linked to supporting structural bodies is described in Patent Literature 1.

### CITATION LIST

### Patent Literature

### Patent Literature 1: Japanese Unexamined Patent Application Publication 2008-303882

### SUMMARY OF INVENTION

### Technical Problem

According to the contents stated in Patent Literature 1, conductors for detecting deflection are built into supporting structural bodies made of glass fiber bundles or epoxy resin and carriers removably linked to supporting structural bodies. However, when arrangement is made with building into glass fiber bundles or epoxy resin, the surroundings of the sensor may conceivably become the starting point of damage. Or when some carrier member is to be separately provided, it is difficult to make the structure simple.

The present invention, in view of the above-stated problems of the prior art, is intended to provide a blade for wind power generation or a wind power generation device that can measure the quantity of blade deformation with a simple structure while enhancing the reliability of structure.

### Solution to Problem

In order to solve the problems stated above, the blade for wind power generation according to the present invention includes a front edge part, a rear edge part, a spar cap configured to contain a fiber-reinforced layer, a shell core arranged at least between the front edge part and the spar cap or between the rear edge part and the spar cap, and a non-conductive sensor, wherein a concave is formed in a surface of the shell core and the non-conductive sensor is arranged in the concave.

Further, the wind power generation device according to the present invention includes the blade for wind power generation, a hub supporting the blade, a nacelle rotatably supporting the blade for wind power generation and the hub, and a tower supporting the nacelle.

### Advantageous Effects of Invention

According to the present invention, it is possible to provide a blade for wind power generation or a wind power generation device that can measure the quantity of deformation of blades with a simple structure while enhancing the reliability of structure.

### BRIEF DESCRIPTION OF DRAWINGS

FIG. 1(A) is a schematic diagram showing the overall configuration of an upwind windmill.

FIG. 1(B) is a schematic diagram showing the overall configuration of a downwind windmill.

FIG. 2 is a perspective view of a blade for wind power generation pertaining to a comparative example.

FIG. 3 is an A-A′ sectional view illustrated in FIG. 2.

FIG. 4 is a sectionally expanded view of a section B illustrated in FIG. 3.

FIG. 5 is a perspective view of a blade for wind power generation representing a first embodiment of the present invention.

FIG. 6 is a C-C′ sectional view illustrated in FIG. 5.

FIG. 7 is a sectionally expanded view of a section D illustrated in FIG. 6.

FIG. 8 is a perspective view of a blade for wind power generation representing a second embodiment of the present invention.

FIG. 9 is an E-E′ sectional view illustrated in FIG. 8.

FIG. 10 is a sectionally expanded view of a section F illustrated in FIG. 9.

FIG. 11 is a perspective view of a blade for wind power generation representing a third embodiment of the present invention.

FIG. 12 is a G-G′ sectional view illustrated in Fig. the cable 13.

FIG. 13 is a sectionally expanded view of a section H illustrated in FIG. 12.

### DESCRIPTION OF EMBODIMENTS

Plural embodiments of the present invention will be described below with reference to drawings. It is to be noted, however, that the dimensions, material, shape and relative arrangement described in these embodiments are not intended to be thereby limited, but nothing more than descriptions cited as examples.

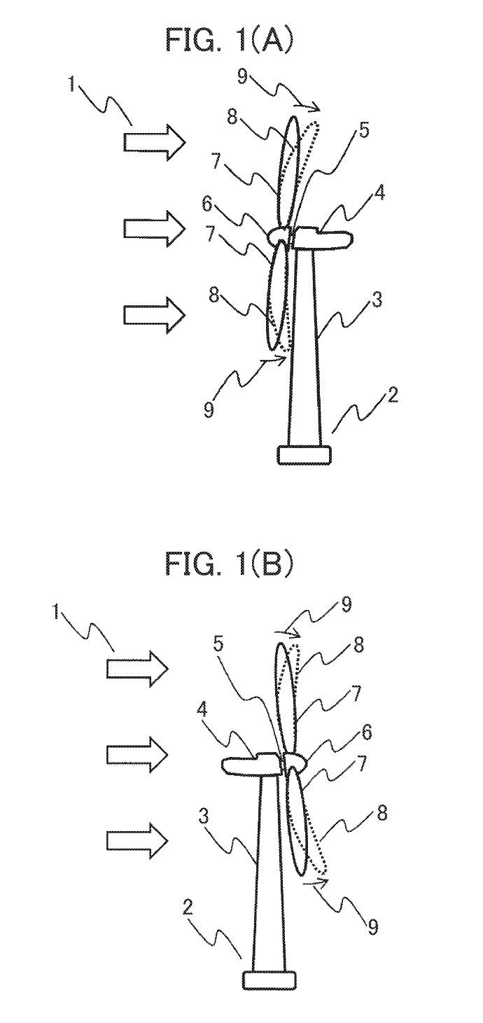

First, the structures of the wind power generation device and the wind power generation blade will be described. FIGS. 1(A) and (B) show a horizontal axis wind turbine. A wind power generation device 2 is primarily configured of a tower 3, a nacelle 4 installed in the upper part of the tower 3 so that it can be rotationally driven within a horizontal face, and a rotor connected to the nacelle 4 and hubs 6 each configured of one or another of three blades 7 and arranged at the center of each of the blades 7. Electric power generation is operated by using the rotational energy of the rotor to drive the main shaft and a generator connected via, for instance, an accelerator. Such a horizontal axis wind turbine is classified into an upwind system in which the rotor shown in FIG. 1(A) is arranged farther windward side than the tower and the nacelle and a downwind system in which the rotor shown in FIG. 1(B) is arranged farther leeward side than the tower and the nacelle; the blade 7 receiving wind 1 is bend-deformed in the leeward direction involving twist.

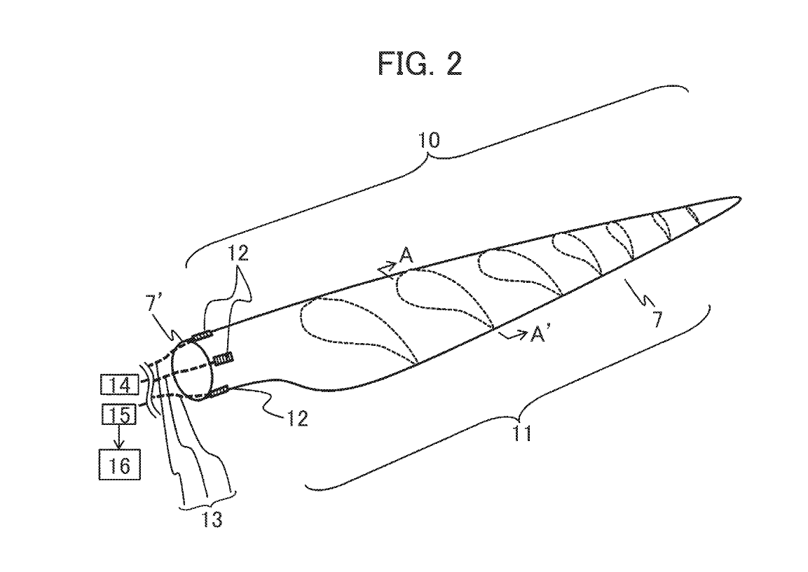

FIG. 2 shows a perspective view of the wind power generation blade 7 shown as the comparative example in which at least one each of an optical fiber type sensor 12 and an optical cable 13 for measuring distortion to be connected to the hub 6 are arranged near a root 7′. In the main body of the windmill not shown, a light source part 14, a light receiving part 15 and a data collecting device 16 are disposed. The configuration used is such that dynamic physical quantities including loads and moments working on the blade subjected to the wind 1 are measured with the sensor 12 and fed back for windmill control.

Since a blade for wind power generation is required to be light in weight and high strength characteristics, blades for wind power generation of spar cap structure are used in which main structural members known as spar caps are arranged restrictively in the outer shell near the thickest part (in terms of the positive pressure side and the negative pressure side thicknesses) of the section of the wing.

FIG. 3 shows a sectional view a blade for wind power having this spar cap structure. Referring to FIG. 3, in the blade 7, there are spar caps 17 respectively arranged on the positive pressure side 22 that receives wind and the downstream side negative pressure side 23, and a front edge side shear web 19a and a rear edge side shear web 19b each connecting the respective spar caps 17 on the positive side and the negative side with adhesive 20. Although FIG. 3 shows an example in which the number of shear webs arranged is two, obviously the number of shear webs to be arranged is not limited to two. Also, a lightning conductor 21 that causes the lightning current to be let flow when the blade 7 has been hit by lightning may be disposed within the blade 7 (more specifically on the rear edge side shear web 19b in FIG. 3). Although the drawing shows an example in which the lightning conductor 21 is fixed to the rear edge side shear web 19b, the fixing position or the fixing method for the lightning conductor 21 can as well be different from what is illustrated here. Each of the shells 18 in the half-split shape on the pressure side and the negative pressure side are joined by the adhesive 20 at the front edge 10 side and the read edge 11 side of the spar caps 17.

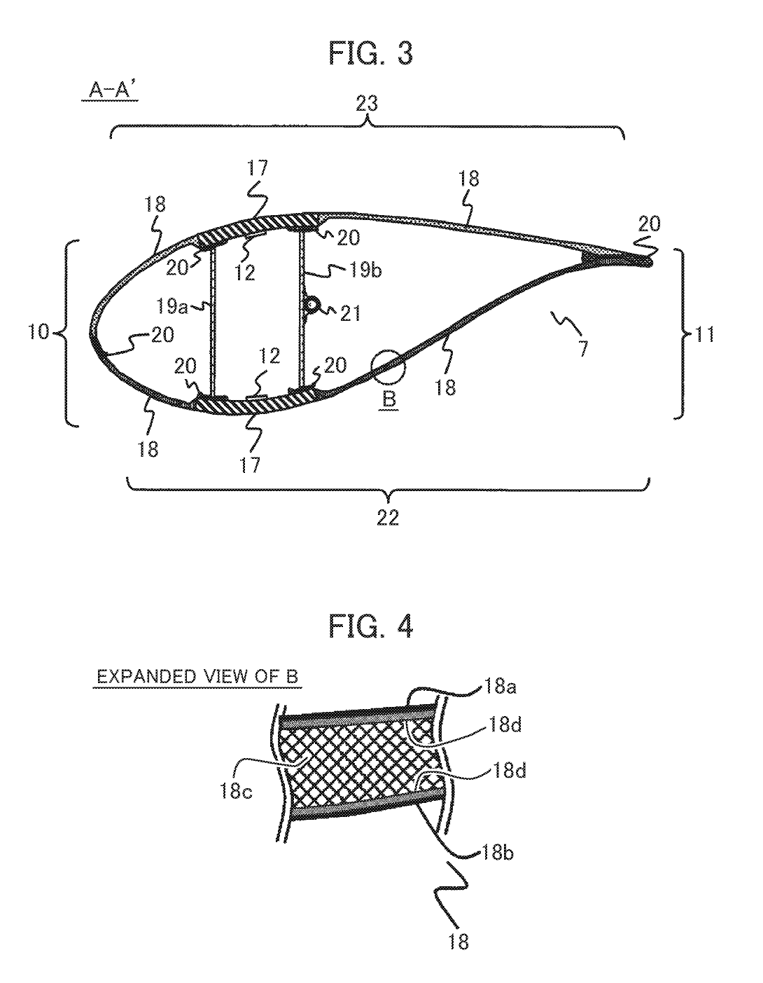

FIG. 4 shows an expanded section of the B part of the shell 18 in the blade 7. An inner side skin material 18c disposed between the outer side skin material 18b and the inner side skin material 18a formed of FRP covering the whole of the negative pressure side 22 and the positive pressure side 23 of the blade 7 and the outer side skin layer 18a and the inner side skin layer 18b is shaped and fixed by impregnating resin 18d. It is a member arranged for the purpose of increasing the rigidity of the shell 18 to prevent its buckling, for which cellular porous medium of polyvinyl chloride (PVC) or light-weight wood, such as balsa wood is used.

As stated above, the technique of measuring distortion with an optical fiber type sensor is known. Here, a method is conceivable by which the optical fiber type sensor is adhered to the inner surface or the outer surface, or to the surface of the root part. In FIG. 3, between the front edge side shear web 19a and the rear edge side shear web 19b of the blade 7, the sensor 12 for measuring the quantity of distortion in the lengthwise direction of the blade is disposed. The sticking position of the sensor 12 is not limited to between the shear webs, and it can be stuck to any position where measuring of distortion is desired.

The usual method of blade manufacturing is to adhere plural pre-molded members with adhesive to forma wing shape. Since pre-molded members involve errors in machining dimensions, assembly is done after the adhesive is thickly stuck (even more thickly than the actually needed thickness) to reduce influence of such errors. The adhesive hardens in a state in which surplus adhesive remains forced out of the adhered area. This surplus adhesive may be caused to come off by centrifugal force or otherwise when the windmill is at work. Since the freed lump of adhesive jumps around within the blade when the blade turns, it may damage the optical fiber type sensor which is a structural member on the inner surface of the blade.

Further, there is a method by which the sensor is stuck to the inner surface of the blade 7 after the blade 7 is completed. In this case, the wing thickness of the blade 7 (the combined length of the positive pressure side and the negative pressure side) decreases toward the tip. Therefore, it is difficult, on account of the restriction of the blade working space, to stick the sensor to the blade 7 after the formation of the wing shape. Therefore, the area where the distortion can be measured is limited, and the quantity of deformation at the blade tip is measured in some other way. Or some other means such as theoretical estimation are required, making it impossible to obtain the quantity of deformation of the whole blade precisely.

Further, when an optical fiber sensor is inserted between the layers of FRP-laminated material to detect damage such as delamination, generally the sectional diameter of FRP-reinforced fibers is 5 to 15 μm. On the other hand, for optical fiber sensors, the core propagated by light is several μm to several tens of μm, and the concentric clad covering its surroundings is, for instance, about 125 μm. Therefore, when an optical fiber sensor is embedded between layers of or into any layer of FRP laminated material, the surroundings of the optical fiber sensor may become the start point of damages, which suggests the fear of deterioration of the reliability of the FRP laminated material.

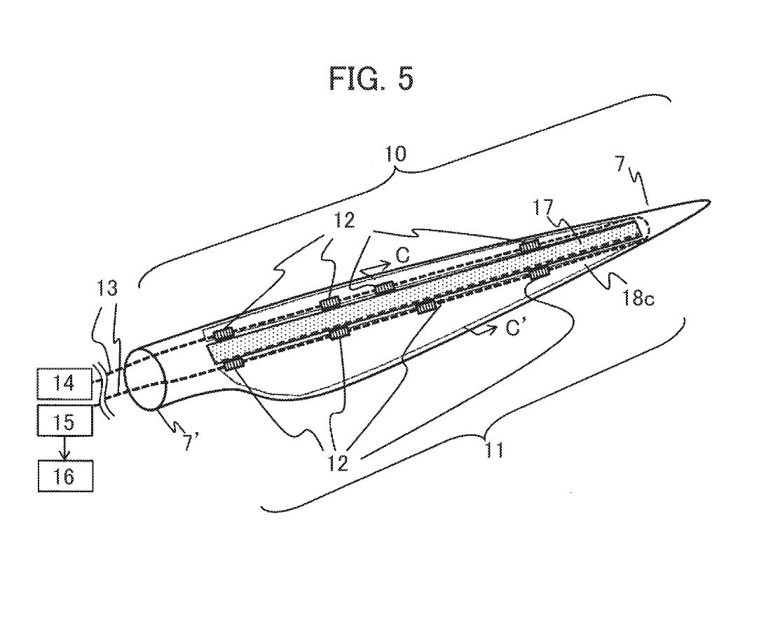

FIG. 5 shows a perspective view of a wind power generation blade, which is a first embodiment of the present invention. FIG. 5 shows a view of the blade 7 from the negative pressure side 22.

The optical cable 13 in which at least one optical sensor 12 is discretely connected is arranged so as to go around the tips of the spar caps 17 while going along the spar caps 17 towards the tip of the blade 7 on the connection border between the spar cap 7 on the front edge 10 side and the shell core 18c, and arranged so as to go along the spar caps 17 towards the root part 7′ of the blade 7 on the connection border between the spar cap 7 on the rear edge 11 side and the shell core 18c. Incidentally, the spar caps are arranged from the very front tip to the root side in the tip side of the blade in the lengthwise direction, and accordingly the optical cable 13 is enabled to be so arranged as to go around the front end side tip of the spar caps 17. The end part of the front side edge 10 side arranged on the optical cable 13 toward the front side edge 10 is connected to the light source part 14, and the end part of the cable 13 arranged toward the rear edge 11 side is connected to the light receiving part 15. Regarding the position where the optical cable is connected, the combinations between the front side tip and the rear side tip and between the light source part and the light receiving part are not limited to what is shown in this diagram.

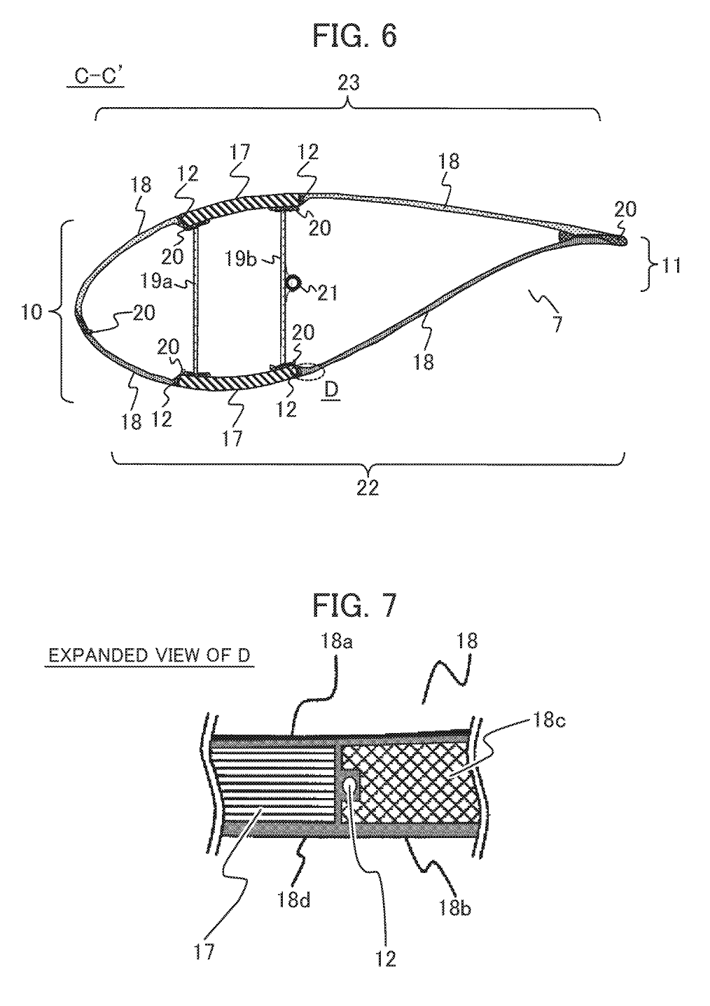

The arranged position of the optical cable described with reference to FIG. 5 will be described in detail with reference to FIG. 6 and FIG. 7. FIG. 6 shows an arrow view of the C-C′ cross section in FIG. 5. The connection boundary part between the spar cap 17 and the shell 18 shown in FIG. 6 is present on each of the positive pressure side 22 and the negative pressure side 23 as well as the front edge 10 side and the rear edge 11 side, and the optical sensor 12 is disposed on the shell 18 side in the boundary part, not on the spar cap 17 side.

The reason why the optical sensor 12 is arranged in the boundary part between the spar caps 17 and the shell 18 and toward the shell 18 instead of toward the spar caps 17 is as follows. The spar caps 17 are main structural members for increasing the strength of the whole blade, and it is undesirable from the viewpoint of strength to form a groove (concave) for containing the optical sensor 12 not only inside but also in the surface. On the other hand, since it is the spar caps 17, which are main structural members, that well reflect the distorting behavior of blades, arrangement closed to the spar caps 17 is desirable. In such a situation where meeting both requirements is difficult, a concave like sensor arrangement is formed. Although the shell core contributes to prevention blade buckling, it does not work as a main structure member unlike spar caps. However, in arranging it on the shell core side, it is not embedded into the shell core, and a concave is formed in its surface to make it difficult for the shell core to suffer cracking or other like trouble.

FIG. 7 shows an expanded view of area D surrounded by dotted lines in FIG. 6. A concave is formed in the face where the shell core 18c connects to the spar caps 17, and the optical sensor 12 and the optical cable 13 not shown in FIG. 7 are arranged here. By arranging the optical sensor 12 and the optical cable 13 farther inside than the upper face of the concave so that they do not protrude from the upper face of the concave, contact with adjoining members and/or contact with debris becomes unlikely. The shell core 18c, the optical sensor 12 and the optical cable 13 are fixed to one another as shown in FIG. 5, and for example, fixed by the impregnating resin 18d.

The process until fixation by the impregnating resin 18d can be accomplished as described below. First, an outer face skin material is arranged over awing shape, followed by arrangement together with a shell material provided with the spar caps and the non-conductor sensor (the optical sensor 12 in this embodiment); further, after arrangement with an inner face skin layer, resin is impregnated while vacuuming to form a wing shape. This wing shape is formed on each of the positive pressure side and the negative pressure side. Next, by performing adhesive connection in the front edge part and the rear edge part with adhesive via the formed shear web material, a blade for wind power generation is configured.

This embodiment enables, without reducing the strength reliability of the spar caps 17 which is a primary structural material of the blade 7, the optical sensor 12 to measure the quantity of distortion suffered by the spar caps 17 when the blade 7 is bending-deformed by wind load. The quantity of bending-deformation can be calculated on the basis of distortion distribution obtained from values measured by the optical sensor 12 discretely arranged in the lengthwise direction of the blade 7.

Further, in order to avoid damage by thunderbolt, the blade 7 is discretely equipped with a thunder receiving part (receptor), which is intentionally made easy to suffer thunder. When the blade 7 suffers thunderbolt, if the sensor 12 and/or the cable 13 are conductors, they are susceptible to the impact of thunder, which may cause electric noise or damage. For this reason, it is desirable to use a non-conducting optical fiber sensor having resistance to noise and electric signals.

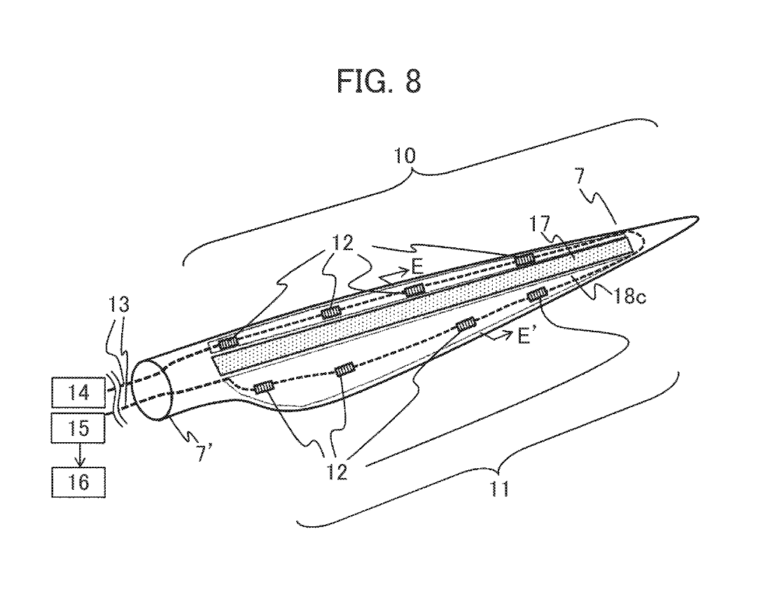

FIG. 8 shows a perspective view of a wind power generation blade, which is a second embodiment of the present invention. FIG. 8 is a diagram showing the blade 7 from the negative pressure side 22. In the embodiment shown in FIG. 5, the shell core 18c on the rear edge side 11 has a concave in the surface of an area adjoining the spar caps 17, but this embodiment is different in that a concave is formed in the face side of the shell core 18c opposing the inner side skin material 18a of the shell 18.

As shown in FIG. 8, the optical cable 13 to which one or more optical sensors 12 are discretely connected is arranged toward the tip side of the blade 7 with respect to the shell core 18c part on the front end edge 10 side and, after it is so arranged as to run around the tip of the spar caps 17, arranged on the rear edge 11 side shell core 18c toward the root part 7′ of the blade 7.

In this arrangement, the optical sensor 12 and the optical cable 13 need not be directed in the same direction as the lengthwise direction of the blade but may as well be so arranged that the positions of the optical sensor 12 and the optical cable 13 in the blade width direction vary in the lengthwise direction of the blade. The variation in the blade width direction in other words leads to variation of, for instance, the distance from the spar caps 17. The blade width direction in this context means the direction of connecting the front edge to the rear edge, which is a direction substantially vertical to the lengthwise direction of the blade. The arrangement in this embodiment with an inclination of 45 degrees or 135 degrees with respect to the blade lengthwise direction allows measurement of the distortion arising when the blade 7 is subjected to torsional deformation. Discrete arrangement to the blade 7 allows calculation of the quantity of deformation of the whole blade 7. The tip of the optical cable 13 arranged toward the front edge side 10 is the light source part 14, and the end part of the cable 13 arranged toward the rear edge side 11 is connected to the light receiving part 15. Further, regarding the position of connecting the optical fiber cable, the combination between the front edge and the rear edge and between the light source part and the light receiving part is not limited to what is shown in this diagram.

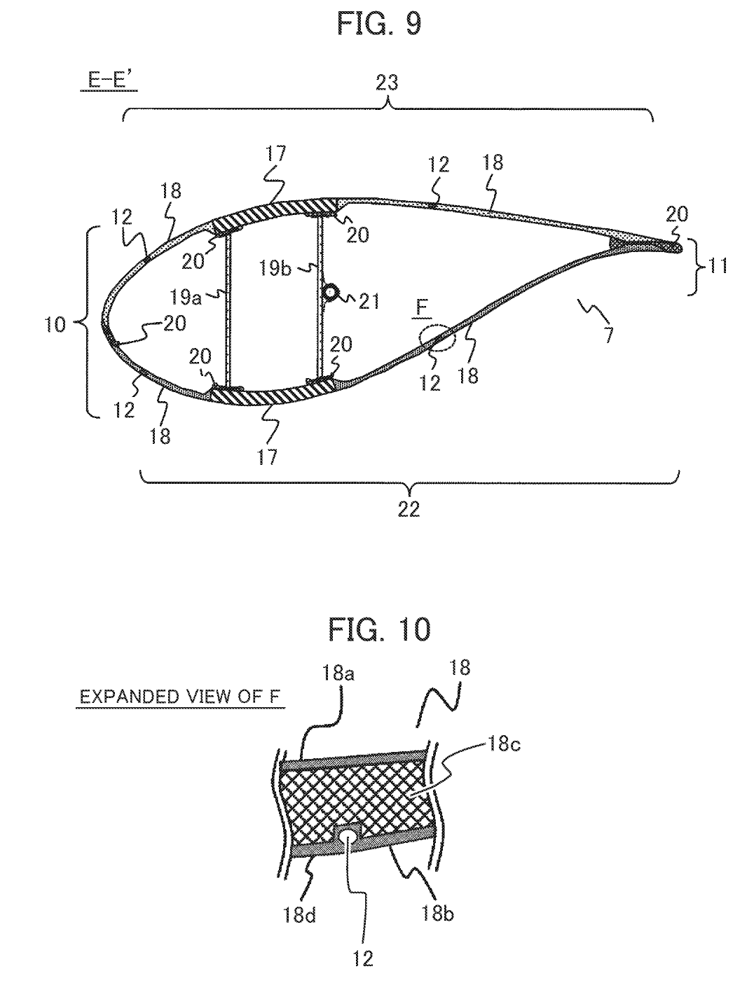

The arrangement positions of the sensor and the cable described with reference to FIG. 8 will be described in detail by using FIG. 9 and FIG. 10. FIG. 9 shows an arrowed view of the E-E′ section in FIG. 8. Although the embodiment shown in FIG. 9 represents an example in which one each is arranged in the shell cores 18c on the positive pressure side 22 and the negative pressure side 23 and on the front edge 10 side and the rear edge 11 side, the number of the sensors to be arranged can be determined as desired.

FIG. 10 shows an expanded view of an area F surrounded by dotted lines in FIG. 9, wherein a concave is disposed toward the face side of the shell core 18c opposing the outer side skin material 18b of the shell 18, and the optical sensor 12 and the optical cable 13, not shown in FIG. 10, are arranged. The shell core 18c, the optical sensor 12 and the optical cable 13 are fixed by the impregnating resin 18d. The area to be measured can be determined as desired, and the face in which a concave is to be formed may as well be a face of the shell core 18c opposing the inner side skin material 18a.

This embodiment enables, when the blade 7 is deformed by wind load, the quantity of distortion occurring in the shell 18 to be measured by the optical sensor 12 without reducing the strength reliability of the inner side skin material 18a and the outer side skin material 18b formed of FRP laminated materials constituting the shell 18 of the blade 7. Furthermore, the structural soundness of the shell 18 can be monitored according the presence or absence of signals from the sensor 12.

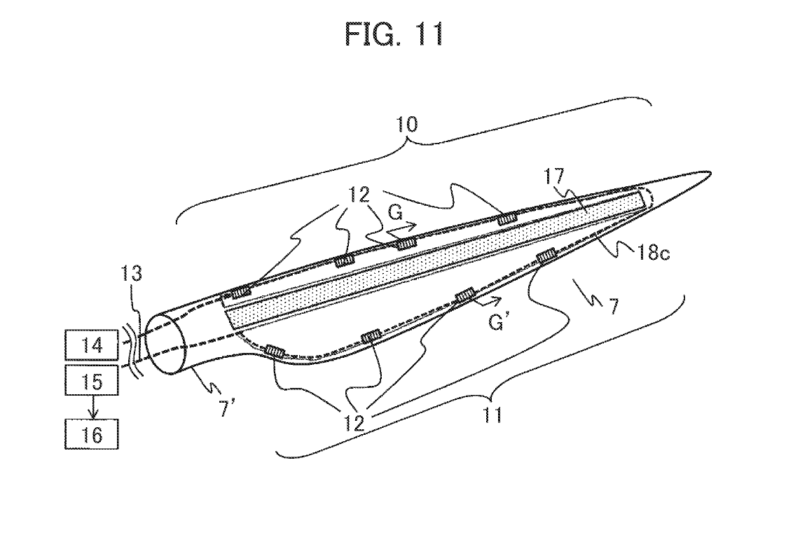

FIG. 11 shows a perspective view of a wind power generation blade, which is a third embodiment of the present invention. FIG. 11 is a diagram showing the blade 7 from the negative pressure side 22. This embodiment differs in that concaves are formed on the front side edge 10 of the shell core 18c and the rear edge 10 side of the shell core 18c.

After arranging the optical cable 13 to which one or more optical sensors 12 are discretely connected toward the tip side of the blade 7 with respect to the vicinity of the front edge 10 side edge side of the shell core 18c and further so arranging it as to run around the tips of the spar caps 17, it is arranged toward the root part 7′ of the blade 7 regarding the vicinity of the rear edge side 11 side tip of the shell core 18c. The tip of the optical cable 13 arranged on the front edge 10 side is connected to the light source part 14, and the tip of the cable 13 arranged on the rear edge side 11 is connected to the light receiving part 15. Further, regarding the connected position of the optical fiber cable, the combinations of the front edge and the rear edge and of the light source and the light receiving part are not limited to what is shown in this diagram.

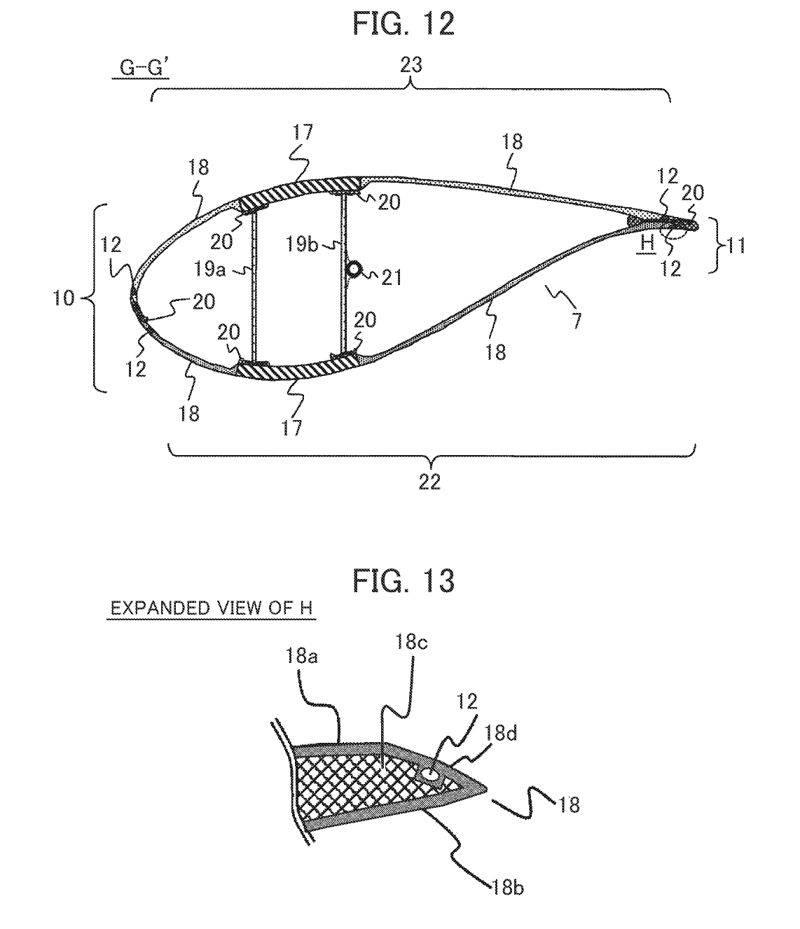

The arranged positions of the sensor and the cable described with reference to FIG. 11 will be described in further detail with reference to FIG. 12 and FIG. 13. FIG. 12 is an arrowed drawing along the G-G′ section in FIG. 11. In the embodiment shown in FIG. 12, the positive pressure side 22 and the negative pressure side 23 are arranged in one position each in the vicinity of the front edge 10 side end and the rear edge 11 side end of the shell core 18c, but the number of the sensors can be determined as desired.

FIG. 13 shows an expanded view of the area H surrounded by dotted lines in FIG. 12, wherein, in the vicinity of the tip of the shell core 18c on the rear edge 11, a concave is disposed near the edge part of the face opposing the inner side skin material 18a of the inner side skin material 18a, where the optical sensor 12 and the optical cable 13, which is not shown in FIG. 13, are arranged. The shell core 18c, the optical sensor 12 and the optical cable 13 are fixed by the impregnating resin 18d. It is possible to determine the area to be measured as desired, and the face in which the concave is to be disposed may as well be the face of the shell core 18c opposing the outer side skin material 18b.

Since the FRP laminated material constituting the shell 18 of the blade 7 the front edge side 10 or the rear edge side 11 is located where the shape is discontinuous or abruptly varies, there may occur cracks in the adhesive part 20 or elsewhere, and any damage on the shell 18 side may expand or rainwater or the like may invade into the blade 7. Therefore, by monitoring the quantity of distortion measured or measurement signals obtained by this embodiment, it is possible to monitor of the structural soundness of not only the blade but also of the windmill itself.

The present invention is not limited to the above-described embodiments, and the following variations are conceivable for instance.

(1) Although the optical sensor 12 is arranged in the shell 18 according to the above-described embodiments, it can as well be applied to members having shell core material; for instance, the shear web 19 can include a cellular porous medium of polyvinyl chloride (PVC) or light-weight wood, equivalent to shell core material or light-weight wood such as balsa wood.
(2) The plural embodiments cited above may be configured independently according to the purpose, but their combination would make direct detection of the operating state of the blade 7 possible.
(3) There is no particular limitation regarding the type of optical fiber sensor to be used; sensors of FBG (Fiber Bragg Grating) less susceptible to electrical trouble caused by deteriorated insulation may be used as well; and a system permitting distributed distortion measurement over the whole length of the optical fiber sensor such as Brillouin Optical Correlation Domain Analysis (BOCDA) or permitting dynamic distortion measurement in any desired position of the optical fiber sensor can be applied.
(4) The impregnating resin used for formation of the blade according to the present invention should preferably unsaturated polyester resin, vinyl ester resin or epoxy resin, and the means should preferably include a step of impregnating resin during vacuuming. The use of glass fiber or carbon fiber as reinforcing fiber is preferable in ensuring light weight and strength reliability.

### LIST OF REFERENCE SIGNS

1 . . . Wind; 2 . . . Wind power generation device; 3 . . . Tower; 4 . . . Nacelle; 5 . . . Main shaft; 6 . . . Hub; 7 . . . Blade; 7′ . . . Blade root connecting part; 8 . . . Blade after deformation; 9 . . . Deforming direction of blade; 10 . . . Front edge side; 11 . . . Rear edge side; 12 . . . Optical fiber sensor; 13 . . . Optical fiber cable; 14 . . . Light source part; 15 . . . Light receiving part; 16 . . . Data logger; 17 . . . Spar cap; 18 . . . Shell; 18a . . . Outer side skin material of shell; 18b . . . Inner side skin material of shell; 18c . . . Shell core; 18d . . . Impregnating resin; 19a . . . Front edge side shear web; 19b . . . Rear edge side shear web; 20 . . . Adhesive; 21 . . . Lightning conductor; 22 . . . Positive pressure side, 23 . . . Negative pressure side

1. A blade for wind power generation comprising:
a front edge part;
a rear edge part;
a spar cap configured to contain a fiber-reinforced layer;
a shell core arranged at least between the front edge part and the spar cap or between the rear edge part and the spar cap; and
a non-conductive sensor,
wherein a concave is formed in a surface of the shell core and the non-conductive sensor is arranged in the concave.

2. The blade for wind power generation according to claim 1, wherein the concave is formed in the surface of the shell core opposing the spar cap.

3. The blade for wind power generation according to claim 2,
wherein the shell core is arranged between the front edge part and the spar cap and between the rear edge part and the spar cap, and
the concave is formed in the surface of the first shell core arranged between the front edge part and the spar cap and in the surface of the second shell core arranged between the rear edge part and the spar cap, the surface of the second shell opposing the spar cap.

4. The blade for wind power generation according to claim 3,
wherein the first shell core and the second shell core are respectively arranged on a positive pressure side and a negative pressure side.

5. The blade for wind power generation according to claim 1,
wherein the concave is formed in a surface of shell core opposing at least the front edge part or the rear edge part.

6. The blade for wind power generation according to claim 1, the blade comprising an outer skin layer covering an outer face and an inner skin layer covering an inner skin layer,
wherein the shell core surface is a surface on a side facing the outer skin layer or the inner skin layer.

7. The blade for wind power generation according to claim 6,
wherein the concave is so formed as to differ in position in the breadthwise direction in the lengthwise direction of the blade for wind power generation.

8. The blade for wind power generation according to claim 1 comprising a shear web that links the positive pressure side and the negative pressure side in the blade for wind power generation,
wherein the non-conductive sensor is arranged in the shell core constituting the shear web.

9. A wind power generation plant comprising:
the blade for wind power generation in claim 1;
a hub supporting the blade;
a nacelle rotatably supporting the blade for wind power generation and the hub; and
a tower supporting the nacelle.
